(19) United States
(12) Patent Application Publication
(10) Pub. No.: US 2010/0126924 A1
(43) Pub. Date: May 27, 2010

(54) ANTI-ROTATION OF SHELL RELATIVE TO NUTPLATE

(75) Inventors: Charles W. Hawkins, Sparta, TN (US); William R. Knox, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP INC., Minneapolis, MN (US)

(21) Appl. No.: 12/277,643

(22) Filed: Nov. 25, 2008

(51) Int. Cl. B01D 35/34; B23P 11/00

(52) U.S. Cl. 210/232; 29/505

(57) ABSTRACT

A filter assembly having anti-rotation features that prevent rotation of a shell relative to a nutplate and a method of forming the disclosed filter assembly are described. The disclosed method radially deforms a flange of the housing to the shape of the pre-formed anti-rotation features, and does not utilize a secondary operation such as a staking operation to stake selected edge portions.

### FIELD

This disclosure relates generally to fluid filtration, and more particularly to a filter assembly that includes a shell and a nutplate.

### BACKGROUND

A known type of filter assembly used in a vehicle engine such as a diesel engine includes a filter housing or shell, a filter cartridge that is disposed within the filter housing and a nutplate for closing an open end of the filter housing.

In these types of filter assemblies, the nutplate is usually provided with both an upper groove and a lower groove on an outer edge. The lower groove is configured to seat an O-ring, while the upper groove circumscribes the upper portion of the filter housing.

A roll forming operation is usually performed to deform the filter housing into the upper groove of the nutplate. This roll forming operation is typically followed by a secondary operation such as a staking operation to stake the housing into the groove to prevent the filter housing from slipping or rotating relative to the nutplate during filter installation or removal.

### SUMMARY

A filter assembly that includes a nutplate having pre-formed anti-rotation features that prevent rotation of the shell relative to the nutplate and a method for producing the disclosed filter assembly are described. The disclosed method radially deforms a flange of the housing to the shape of the pre-formed anti-rotation features, and does not utilize a secondary operation such as a staking operation to stake selected edge portions. The filter assembly described herein can be used in automotive/diesel truck engines for filtering various engine fluids including but not limited to fuels such as diesel fuel, oils, and hydraulic fluids.

In one embodiment, the disclosed filter assembly includes a housing, which is also referred to as a shell, having a side wall, a base portion, an open end and an interior space and a nutplate, which is also referred to as a retainer, having fluid inlet openings that extend through the nutplate and direct fluid to be filtered into the interior space, a hub having an opening through which filtered fluid exits the filter assembly, and a sidewall. The sidewall of the nutplate is provided with a groove that includes a plurality of pre-formed anti-rotation features. In one example, each of the preformed anti-rotation features is a faceted region and the groove further includes a plurality of contour regions, the contour regions and the faceted regions alternating with each other around the groove. The housing further includes a portion proximate to the open end that is disposed within the first groove and that conforms to the plurality of pre-formed anti-rotation features.

In one embodiment of the method of forming the disclosed filter assembly, a seamer machine is utilized for performing a seaming operation. In one example, a profile roll is advanced into a flange of the housing that is disposed within the groove on the nutplate using a servo actuator within the seamer machine. The seaming operation is then performed so that the profile roll engages the flange of the shell, and the servo actuator follows the shape the groove of the nutplate such that the flange is radially deformed to conform the flange to the shape of the groove including the pre-formed anti-rotation features.

### BRIEF DESCRIPTION OF THE DRAWINGS

FIG. 1A is a cross-sectional side view of the assembled filter assembly.

FIG. 1B is an enlarged view of the dotted outline area in FIG. 1A.

FIG. 2A is a perspective view of the nutplate of the filter assembly.

FIG. 2B is an enlarged view of the dotted outline area in FIG. 2A.

FIG. 3A is a cross-sectional side view of the nutplate of the filter assembly.

FIG. 3B is a cross-sectional top plan view of the nutplate of FIG. 3A.

FIG. 4 is an enlarged view of the dotted outline area in FIG. 3B.

FIG. 5A is a partial cross-sectional side view of the nutplate shown in FIG. 3B.

FIG. 5B is another partial cross-sectional side view of the nutplate shown in FIG. 3B.

FIG. 5C is yet another partial cross-sectional side view of the nutplate shown in FIG. 3B

FIG. 5D is a partial cross-sectional side view of the shell and the pre-formed anti-rotation feature.

FIG. 6 illustrates one embodiment of the disclosed method.

FIG. 7A illustrates a partial cross-sectional side view of the shell and nutplate before deformation.

FIG. 7B illustrates another partial cross-sectional side view of the shell and nutplate before deformation.

### DETAILED DESCRIPTION

A filter assembly having anti-rotation features that prevent rotation of a shell relative to a nutplate and a method of forming the disclosed filter assembly are described. The concepts described herein will be described with respect to a fuel filter assembly in a diesel engine. However, in appropriate circumstances, it is to be realized that the concepts can be applied to other types of filter assemblies as well. In addition, the fluid used can include any vehicle fluids including, but not limited to, oil, fuel such as diesel fuel, hydraulic fluid, etc.

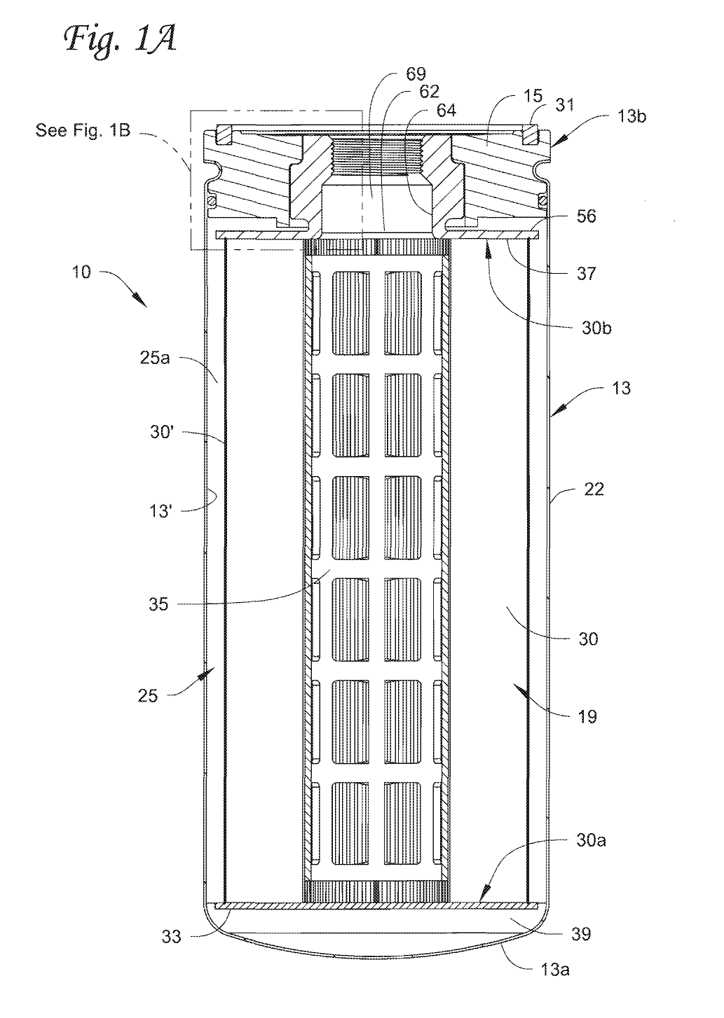

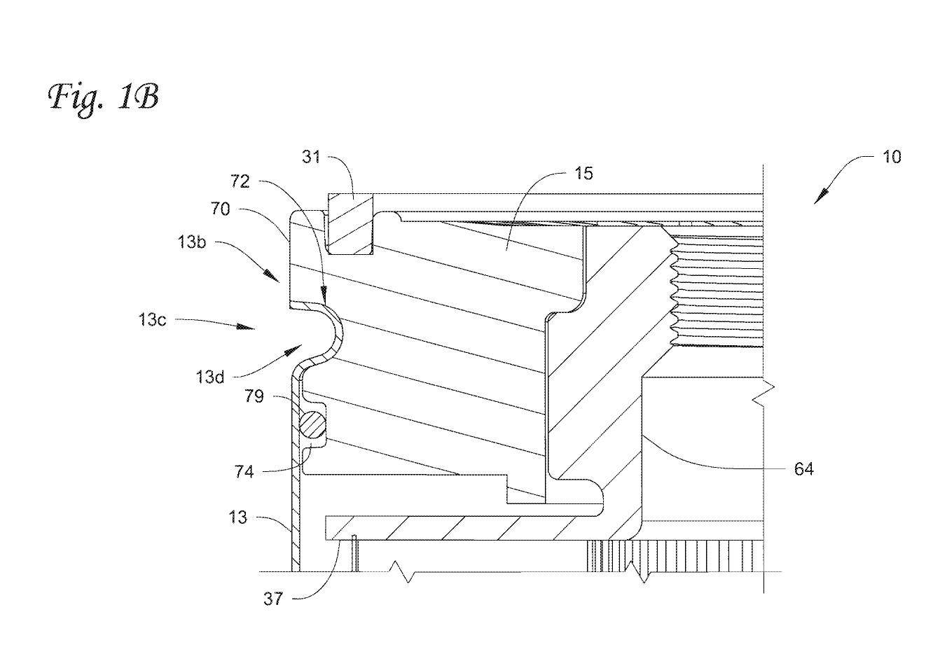

Referring to FIG. 1A, a filter assembly 10 includes a housing 13, a nutplate 15 and a filter element 19. The housing 13 is hollow and cylindrical in shape. The housing 13 has a closed end 13a, an open end 13b, a sidewall 22 and an interior space 25. FIG. 1A shows the housing 13 as being cylindrical, but in appropriate circumstance, the housing 13 could have different shapes. In addition, the material of the housing 13 can be formed of any material that is suitable for forming a shell on a filter assembly, including, but not limited to, aluminum, steel, etc.

A filter element 19 includes a filter media 30, a bottom end plate 33 and a top end plate 37. The filter media 50 can be any filter media that is suitable for filtering fluid with which the disclosed filter assembly is to be used.

The filter media 30 is generally cylindrical and surrounds a center tube 35 which functions to retain the geometrical shape of the filter media 30. During use, an unfiltered fluid enters a space 25a defined between the inner surface 13′ of the housing 13 and the outer region 30′ of the filter media 30, and flows through the filter media 30 toward the center tube 35 so as to filter the fluid.

The bottom endplate 33 is secured to a bottom end 30a of the filter media 30 and is substantially circular. The bottom endplate 33 is provided to prevent filtered fluid from passing to a bottom space 39 of the housing 13 from the center tube 35.

The top endplate 37 is secured to a top end 30b of the filter media 30. The top end plate 37 includes a base plate 56 that is substantially circular and a central opening 62. A sleeve 64 extends upwardly from the edge of the central opening 62 towards the open end 13b of the housing 13 so as to define a flow passageway 69. During use, fluid filtered by the filter media 30 flows through the central opening 62, and into the flow passageway 69 and out the sleeve 64 to an engine.

The material of the bottom endplate 33 and the top endplate 37 can be any material that is suitable for use with the disclosed filter assembly, including, but not limited to, metal, composite, plastic, etc. In addition, the filter media 30 can be secured to the bottom endplate and the top endplate 37 by any means, including, but not limited to adhesives, etc.

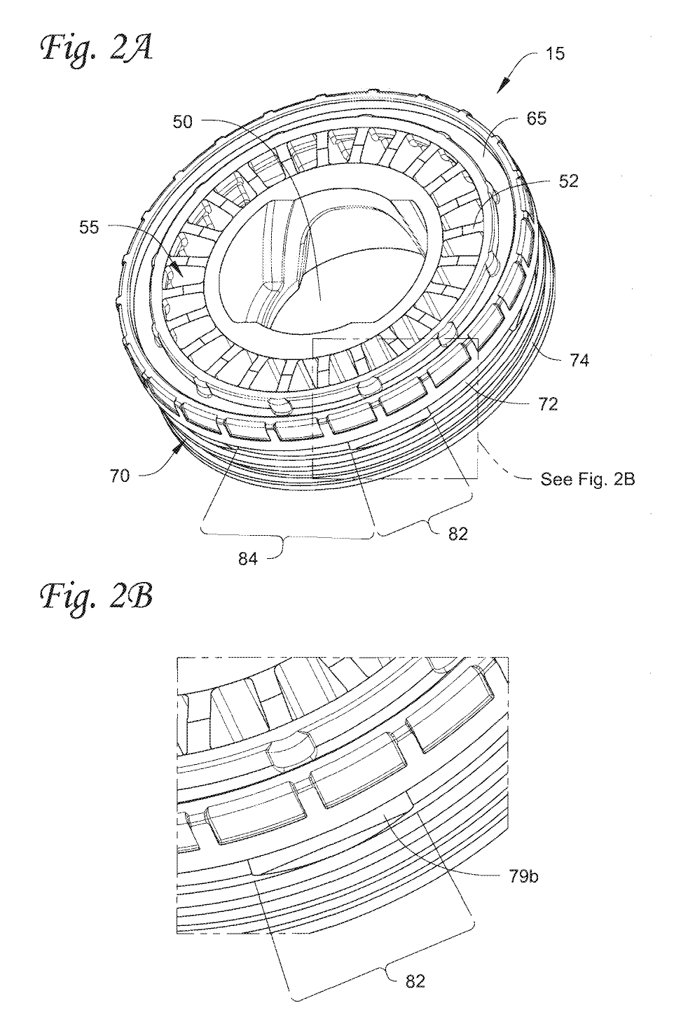

The open end 13b of the housing 13 receives the nutplate 15, which may also be referred to as a retainer. Referring to FIG. 2A, the nutplate 15 includes a hub 50 that receives the sleeve 64 of the top end plate 37 such that the nutplate 15 can be removably mounted to the filter element 19. The nutplate 15 further includes a plurality of ribs 52 between the hub 50 and a sidewall 70 of the nutplate 15. The plurality of ribs 52 define fluid inlet openings 55 that extend through the nutplate 15 and direct fluid to be filtered into the interior space 25. Any number and shapes suitable for use with the disclosed assembly can be used for the ribs 52 and fluid inlet openings 55. A gasket groove 65 is formed in the top surface of the nutplate 15, and a gasket 31 (see FIG. 1A) seats within the groove 65 and functions to seal, for example, a surface surrounding a spud of a diesel engine.

The nutplate 15 can be made of any material suitable for use with the disclosed assembly, including, but not limited to, aluminum, steel, etc.

Referring to FIGS. 1B, 2A and 3A, the sidewall 70 of the nutplate 15 includes an upper groove 72 and a lower groove 74 formed therein. The lower groove 74 seats a seal 79 that provides a seal between the nutplate 15 and the housing 13. The shape of the groove 74 can be any shape that is suitable for seating the seal 79.

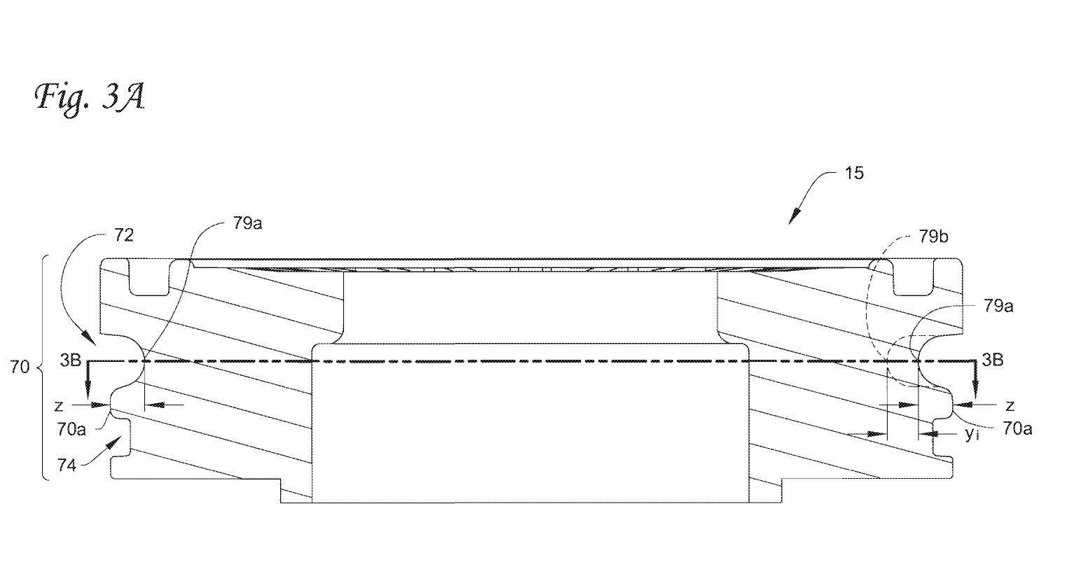

FIG. 3B shows a detailed section taken along axis 3B-3B of FIG. 3A. As shown in FIG. 3B, the outline of a rear wall 79 of the upper groove 72 is substantially circular while the outline of a portion 70a of the sidewall 70 between the grooves 72,74 circumscribes the outline of the rear wall 79, the term “rear” herein being defined as the bottom of the depth of the upper groove 72. The upper groove 72 includes a plurality of contour regions 84 and a plurality of pre-formed anti-rotation features 82, the term “pre-formed” herein being defined as formed before the step of deforming the shell into the groove of the nutplate. In one example, the rear wall 79 includes a rear wall region 79a and a rear wall region 79b. As shown in FIG. 3B, each of the contour regions 84 include the rear wall region 79a, the rear wall region 79a being convex in top plan view, while each of the anti-rotation features 82 is a faceted region such that each of the anti-rotation features 82 includes the rear wall region 79b, the rear wall region 79b being substantially linear in top plan view.

Referring to FIG. 3A, the left-hand portion of the drawing illustrates the cross-sectional side view of one of the contour regions 84 of the upper groove 72. The upper groove 72 within one of the contour regions 84 has a substantially round C-shaped cross-section. The upper groove 72 has a groove depth of z, the term “groove depth” herein being defined as the orthogonal distance from the outer surface of the portion 70a of the sidewall 70 and the rear wall 79 of the groove 72. In one aspect, the groove depth and the width of the upper groove 72 are dependent on the thickness of the housing 13, the thickness of the housing 13 being proportional to the filter application and engine pressures, where higher pressure requirements equal thicker shell wall, which equals larger minimum bend radius. Referring back to FIG. 1B, in the assembled form, a portion 13c proximate to the open end 13b of the housing 13 has a C-shaped groove 13d that conforms to the C-shaped upper groove 72 of the nutplate 15 within the contour regions 84.

Referring now to the right-hand portion of the drawing in FIG. 3A, the cross-sectional side view of one of the faceted regions 82 is illustrated in dotted lines. The upper groove 72 within the faceted regions 82 has a substantially round C-shaped cross-section similar to the C-shaped cross-section within the contour regions 84, but with a deeper groove depth, that is, a groove depth that is greater than z.

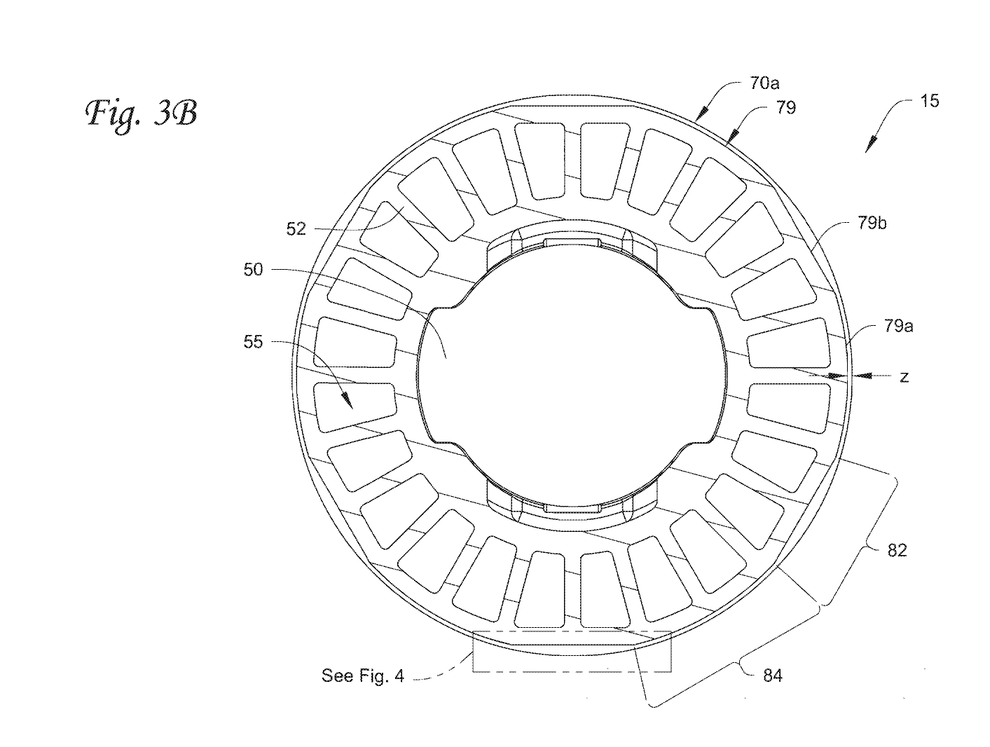

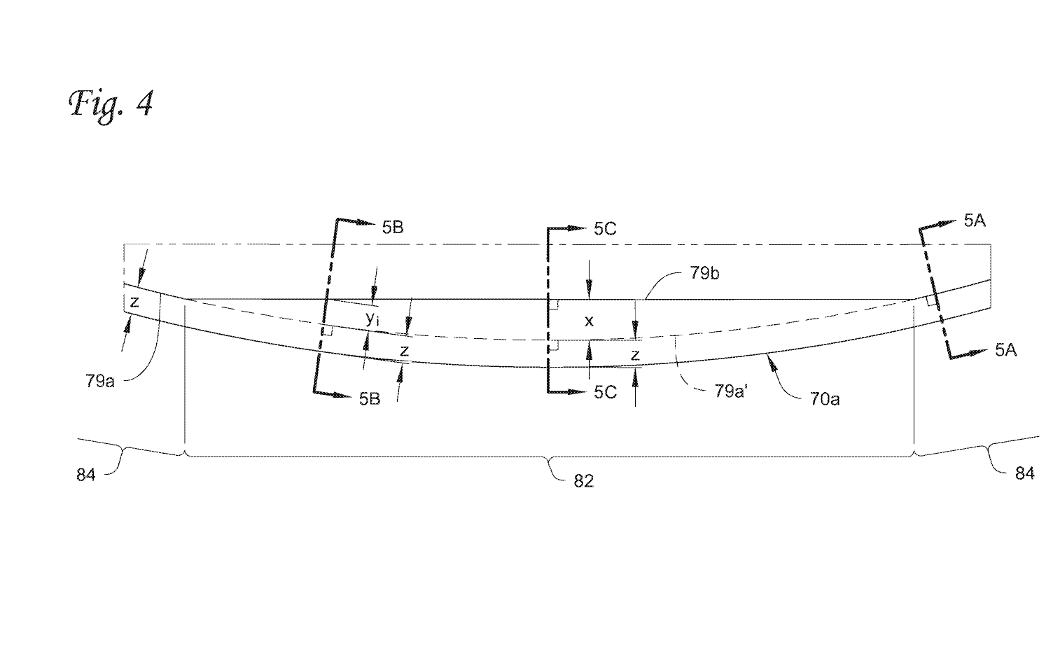

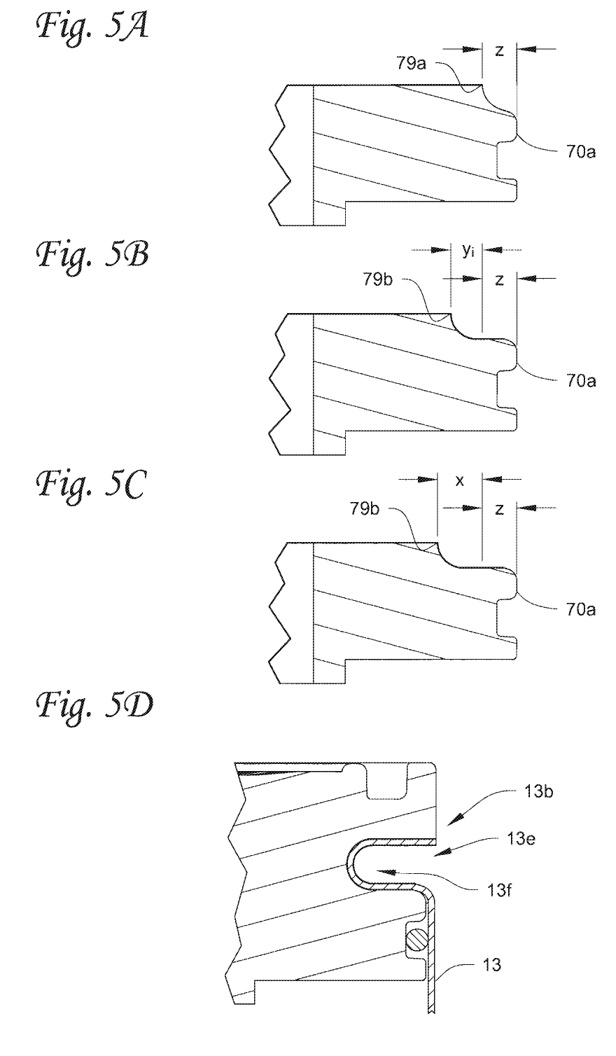

FIG. 4 shows an enlarged view of the dotted outline region of FIG. 3B while FIGS. 5A, 5B and 5C show detailed cross sections taken along axes 5A-5A, 5B-5B and 5C-5C, respectively. FIGS. 4 and 5A show the groove depth within the contour region as being z. Referring to FIGS. 4 and 5C, in the section along the axis 5C-5C, which is orthogonal to and positioned at the mid-point of the outline of the rear wall region 79b, the distance between the mid-point of the outline of the rear wall region 79b and the outline of a hypothetical rear wall region 79a′ (shown in dashed lines in FIG. 4) is defined by x, the outline of the hypothetical rear wall region 79a′ representing the outline of the rear wall region that would be present if the faceted regions 82 were the contour regions 84. The orthogonal distance between the outline of the hypothetical rear wall region 79a′ and the outline of the portion 70a of the sidewall 70 is z. Thus, the groove depth of the upper groove 72 along the axis 5C-5C is x+z. While various configurations of the contour regions 84 and faceted regions 82 are possible, an x value of about 0.170 inch, an x+z value of about 0.217 inch and the rear wall region 79b having a length of about 0.844 inch have produced satisfactory results.

The groove depth decreases away from the axis 5C-5C as illustrated by FIGS. 4 and 5B. The axis 5B-5B is a representative of an axis that is removed from the axis 5C-5C and is orthogonal to the outline of the hypothetical rear wall region 79a′. As shown in FIG. 5B, in the section along the axis 5B-5B, the distance between the outline of the rear wall region 79b and the outline of the hypothetical rear wall region 79a′ is defined by yᵢ, which is smaller than x. In this instance, the groove depth of the upper groove 72 along the axis 5B-5B is yᵢ+z, where yᵢ approaches zero as the axis 5B-5B is further removed from the axis 5C-5C.

Referring to FIG. 5D, in the assembled form, a portion 13e proximate to the open end 13b of the housing 13 has a groove 13f that conforms substantially to the upper groove 72 of the nutplate 15 within the faceted region 82, such that rotation between the nutplate 15 and the housing 13 is prevented.

The figures illustrate the nutplate 15 having six contour regions and six anti-rotation features. Moreover, the figures illustrate the contour regions as being convex in top plan view and having a substantially round C-shaped cross-section in side view and the anti-rotation features as being faceted regions also having a substantially round C-shaped cross-section in side view. However, any number, shapes and sizes can be used for the contour regions and anti-rotation features, as long as the function of preventing rotation between the nutplate and the housing is achieved. For example, the anti-rotation feature may be ribbed, non-round shapes, etc. In one aspect, the diameter of the nutplate 15 will dictate the number of anti-rotation features, so that as the diameter increases, the number of anti-rotation features increases.

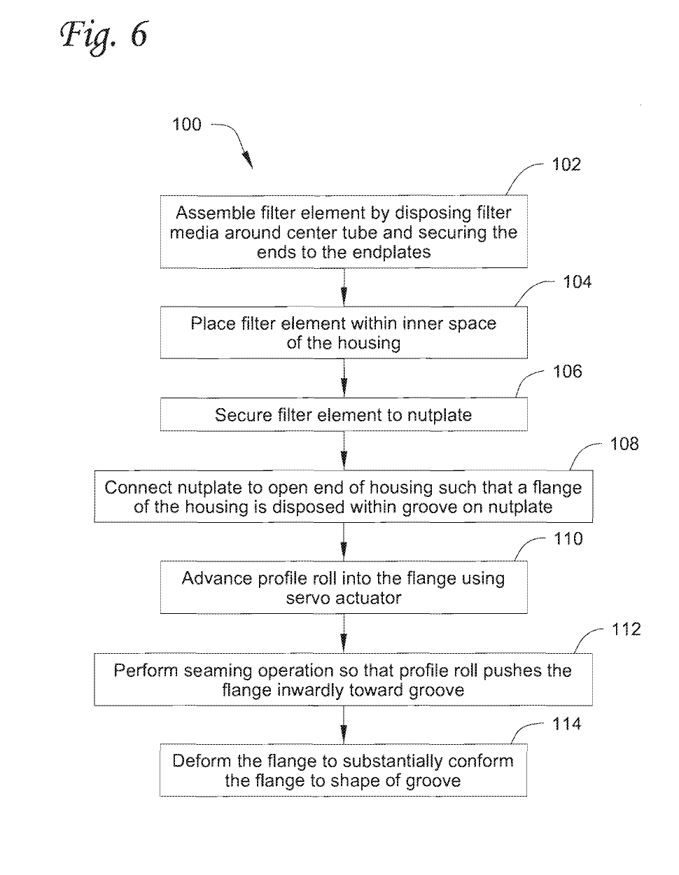

One embodiment of a method for forming the filter assembly 10 will now be described. Referring to FIG. 6, the disclosed method 100 first involves assembling the filter element 19 (step 102). The filter element 19 is assembled by disposing the filter media 30 around the center tube 35, and securing the ends 30a, 30b to the endplates 33, 37. The filter element 19 is then placed within the inner space 25 of the housing 13 (step 104). Once the filter element 19 is placed within the housing 13, the filter element 19 and the nutplate 15 are brought together by fitting the sleeve 64 of the filter element 19 within the central hub 50 of the nutplate 15 (step 106).

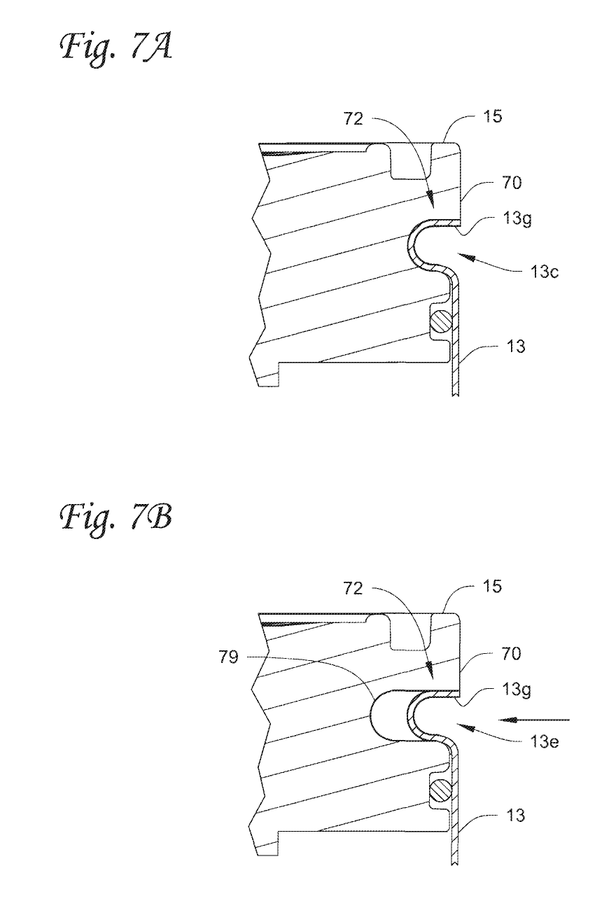

FIGS. 7A and 7B show the state of the portions 13c, 13e of the housing 13 prior to deformation into the upper groove 72 of the nutplate 15. FIG. 7A shows a cross section of the contour region 84 and FIG. 7B shows a cross section of the faceted region 82. The nutplate 15 is connected to the open end 13b of the housing 13 such that a flange 13g of the housing 13 is disposed within the groove 72 on the nutplate 15 (step 108).

In one implementation, a seamer machine is utilized for performing a seaming operation to radially deform the flange 13g so as to conform the flange 13g to the shape of the groove 72. In one example, a profile roll is advanced into the flange 13 using a servo actuator within the seamer machine (step 110). The seaming operation is then performed so that the profile roll pushes the flange 13g inwardly toward the groove 72 (step 112). The profile roll then deforms the flange 13g to substantially conform the flange 13g to the shape of the groove 72 (step 114). In this instance, the servo actuator is capable of following the shape of the groove 72 both in the contour regions 84 and the faceted regions 82, so as to prevent free rotation of the housing 13 relative to the nutplate 15.

The disclosed method eliminates the need for a secondary operation to stake the housing to the nutplate, thereby allowing for a single machine process to produce a filter assembly with anti-rotation features.

While the disclosed filter assembly and methods have been described in conjunction with a preferred embodiment, it will be obvious to one skilled in the art that other objects and refinements of the disclosed filter assembly and methods may be made within the purview and scope of the disclosure.

The disclosure, in its various aspects and disclosed forms, is well adapted to the attainment of the stated objects and advantages of others. The disclosed details are not to be taken as limitations on the claims.

What is claimed is:

1. A nutplate comprising:
fluid inlet openings that extend therethrough;
a hub having an opening therethrough, the fluid inlet openings are disposed between the hub and a sidewall of the nutplate; and
the sidewall having a first groove formed therein, the first groove includes a plurality of pre-formed anti-rotation features.

2. The nutplate of claim 1, wherein each of the anti-rotation features is a faceted region, and the first groove further includes a plurality of contour regions, the contour regions and the faceted regions alternate with each other around the groove.

3. The nutplate of claim 2, wherein in top plan view each of the faceted regions includes a rear wall that is substantially linear.

4. The nutplate of claim 3, wherein each rear wall extends from one of the contour regions to another one of the contour regions.

5. The nutplate of claim 2, wherein in top plan view each of the contour regions is convex.

6. The nutplate of claim 2, wherein each of the faceted regions and each of the contour regions have a substantially round C-shaped cross-section.

7. The nutplate of claim 1, wherein the sidewall includes a second groove formed therein that is axially spaced from the first groove.

8. A filter assembly comprising:
a housing having an open end and an interior space;
a filter element including a filter media that is disposed in the interior space;
a nutplate secured to the housing at the open end thereof, the nutplate including:
fluid inlet openings that extend through the nutplate and direct fluid to be filtered into the interior space,
a hub having an opening through which filtered fluid exits the filter assembly, the fluid inlet openings are disposed between the hub and a sidewall of the nutplate;
the sidewall having a first groove formed therein, the first groove includes a plurality of pre-formed anti-rotation features;
and
the housing includes a portion proximate to the open end that is disposed within the first groove and that conforms to the plurality of pre-formed anti-rotation features.

9. The filter assembly of claim 8, wherein each of the anti-rotation features is a faceted region, and the first groove further includes a plurality of contour regions, the contour regions and the faceted regions alternate with each other around the groove.

10. The filter assembly of claim 9, wherein in top plan view each of the faceted regions includes a rear wall that is substantially linear.

11. The filter assembly of claim 10, wherein each rear wall extends from one of the contour regions to another one of the contour regions.

12. The filter assembly of claim 9, wherein in top plan view each of the contour regions is convex.

13. The filter assembly of claim 9, wherein each of the faceted regions and each of the contour regions have a substantially round C-shaped cross-section.

14. The filter assembly of claim 8, wherein the sidewall includes a second groove formed therein that is axially spaced from the first groove, the second groove seating a seal for sealing between the nutplate and the housing.

15. The filter assembly of claim 8, wherein the filter media is configured to filter fuel, oil, or hydraulic fluid.

16. A method of forming a fluid filter assembly, comprising:
connecting a nutplate to an open end of a housing such that a flange of the housing is disposed within a groove on the nutplate, the groove having a plurality of pre-formed anti-rotation features; and
radially deforming the flange to conform the flange to the shape of the groove including the pre-formed anti-rotation features.

17. The method of claim 16, wherein radially deforming comprises rolling the flange using a profile roll.

18. The method of claim 16, wherein the anti-rotation features comprise a plurality of faceted regions, and radially deforming comprises deforming the flange to conform to the faceted regions.
